(19) United States
(12) Patent Application Publication
(10) Pub. No.: US 2026/0071638 A1
(43) Pub. Date: Mar. 12, 2026

(54) FIXING STRUCTURE

(71) Applicants: TOYOTA JIDOSHA KABUSHIKI KAISHA, Toyota-shi (JP); TOYODA IRON WORKS CO., LTD., Toyota-shi (JP)

(72) Inventors: Masakazu NAGAISHI, Ichinomiya-shi (JP); Motohiro HOSHINO, Toyokawa-shi (JP)

(73) Assignees: TOYOTA JIDOSHA KABUSHIKI KAISHA, Toyota-shi (JP); TOYODA IRON WORKS CO., LTD., Toyota-shi (JP)

(21) Appl. No.: 19/259,356

(22) Filed: Jul. 3, 2025

(30) Foreign Application Priority Data
Sep. 10, 2024 (JP) 2024-156701
Dec. 12, 2024 (JP) 2024-217247

(51) Int. Cl. F16B 2/22

(52) U.S. Cl. CPC F16B 2/22

(57) ABSTRACT

A fixing structure includes a shaft portion, an anchor portion, and a frame portion such that the shaft portion is inserted into the anchor hole, and a locking portion of a locking claw portion engages with an end of the frame portion, wherein a ridge portion is formed at a location of the shaft portion facing a predetermined location on an inner surface of the anchor hole, a groove portion is formed on the inner surface of the anchor hole, the thickness of a portion of the shaft portion at the ridge portion is larger than the width of an opening at a location outside the groove portion of the anchor hole, and the length from a tip portion of the ridge portion to the locking portion of the locking claw portion engaging with the frame portion is smaller than the length in the insertion direction of the anchor hole.

### CROSS-REFERENCE TO RELATED APPLICATION

This application claims priority to Japanese Patent Application No. 2024-156701 filed on Sep. 10, 2024, and to Japanese Patent Application No. 2024-217247 filed on Dec. 12, 2024. The disclosure of each of the above-identified applications, including the specification, drawings, and claims, is incorporated by reference herein in its entirety.

### BACKGROUND

### 1. Technical Field

The present disclosure relates to a fixing structure for fastening two members together.

### 2. Description of Related Art

Japanese Unexamined Patent Application Publication No. 9-032822 (JP 9-032822 A) describes a fastening structure for fixing two members without causing any misalignment therebetween. One member has an elastic arm portion having an arrowhead-shaped locking protruding portion (anchor portion), and a positioning protruding portion formed in the vicinity of the elastic arm portion. The other member has a perforated portion into which the locking protruding portion is to be inserted, and is provided with a locking portion that engages with the locking protruding portion after the locking protruding portion passes through the perforated portion, and a positioning hole that fits to the positioning protruding portion.

According to the disclosure described in JP 9-032822 A, the two members are fixed to each other at two points by the locking member and the positioning portion provided to each of the two members, so that it is possible to fix the two members to each other without causing any misalignment therebetween.

### SUMMARY

The perforated portion and the positioning hole are formed in the other member of the fastening structure described in JP 9-032822 A. With respect to the shapes of these configurations, the shapes as viewed from a surface on the front side may be the same as the shapes as viewed from a surface on the opposite side. In other words, it is difficult to visually distinguish the front and back sides. Therefore, when a fastening work is performed repeatedly, it is unavoidable to fasten the member with the front and back sides thereof reversed, which may cause problems in post-processes or result in rejected products.

The present disclosure has been made in consideration of the above technical problem, and has an object to provide a fixing structure that can prevent incorrect assembly.

A fixing structure includes a shaft portion provided on a first member, an anchor portion having a locking claw portion at a tip portion of the shaft portion, the locking claw portion being elastically expandable and contractible, and a frame portion that is provided on a second member and has an anchor hole into which the shaft portion is to be inserted, the second member being configured to be assembled to the first member such that the shaft portion is inserted into the anchor hole, and a locking portion of the locking claw portion that has passed through the anchor hole engages with an end portion of the frame portion, wherein a ridge portion extending in an insertion direction toward the anchor hole is formed at a location of the shaft portion that is to face a predetermined location on an inner surface of the anchor hole, a groove portion into which the ridge portion can be inserted in the insertion direction is formed at the predetermined location on the inner surface of the anchor hole, a thickness of the shaft portion at the ridge portion is larger than an opening width at a location outside the groove portion of the anchor hole, and a length from a tip portion of the ridge portion to the locking portion of the locking claw portion that is to engage with the frame portion is smaller than a length in the insertion direction of the anchor hole.

Furthermore, according to the present disclosure, the locking claw portion may have an arrowhead shape that is bilaterally symmetrical and gradually narrows on a tip side of the shaft portion, and the locking portion may be formed at a rear end portion of an arrowhead-shaped portion.

In the present disclosure, the locking portion may have a surface that is to engage with a lower surface of the frame portion, and a surface that extends from the surface to a rear end side and is to engage with an inner surface of the frame portion.

In the present disclosure, the shaft portion may have a rectangular sectional shape, the ridge portion may have a rectangular sectional shape, and an opening of the anchor hole may be formed in a rectangular shape.

The present disclosure is configured such that the ridge portion is formed on the shaft portion of the anchor portion, the groove portion is formed in the anchor hole, the thickness of the shaft portion at the ridge portion is larger than the opening width of the anchor hole at a location outside the groove portion of the anchor hole, and the length from the tip of the ridge portion to the locking portion of the locking claw portion that is to engage with the frame portion is smaller than the length in the insertion direction of the anchor hole. Therefore, even when an attempt is made to insert the anchor portion into the anchor hole in a state where the anchor portion is mistakenly turned either upside down or inside out, it is possible to have the tip of the ridge portion of the anchor portion interfere with the frame portion or to prevent the anchor portion from being inserted into the anchor hole because there is no groove portion on the inner surface of the anchor hole. As a result, it is possible to avoid fastening with the front and back sides being reversed during the fastening work, whereby it is possible to prevent incorrect assembling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view and a front view showing a configuration of a fixing structure of the present disclosure;

FIG. 2 is a diagram showing a configuration and an action of the fixing structure of the present disclosure;

FIG. 3A is a partial front view showing a state in which an anchor portion is inserted into an anchor hole in a normal posture; and

FIG. 3B is a partial front view showing a state in which the anchor portion is inserted upside down.

### DETAILED DESCRIPTION OF EMBODIMENTS

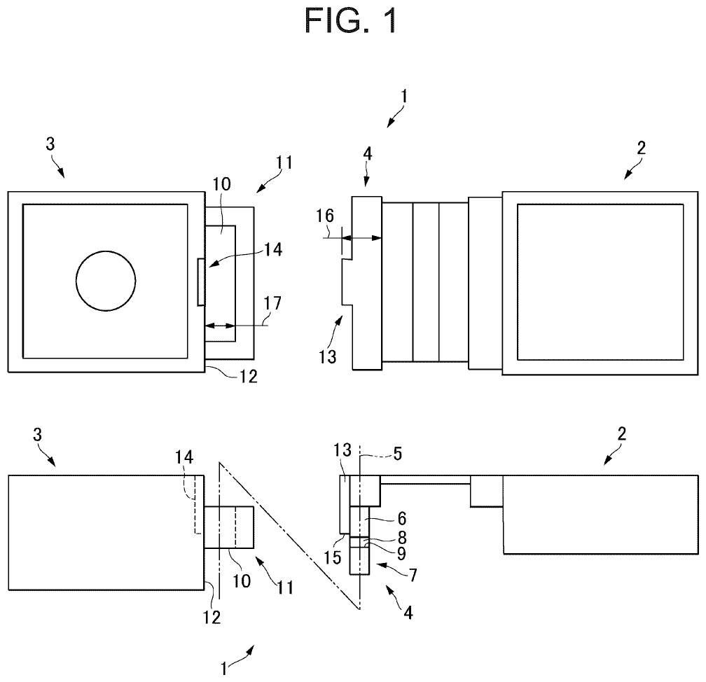

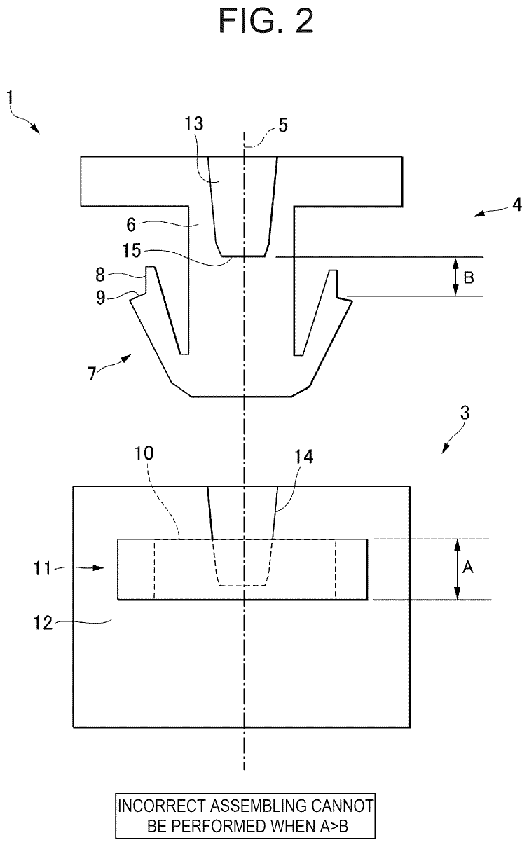

An embodiment of the present disclosure will be described with reference to the drawings. A fixing structure 1 in the embodiment of the present disclosure is configured to connect and fix two members of predetermined first member 2 and second member 3 to each other. A specific configuration will be described with reference to FIGS. 1 and 2.

In the first member 2 which is one member of the fixing structure 1, a hinge member is attached to one side of a rectangular member, and an anchor member 4 is connected to an end portion of the hinge member at a right angle and downward with respect to a direction to the hinge member.

The anchor member 4 includes a plate-shaped insertion portion 6 (corresponding to a shaft portion of the present disclosure) extending along an anchor axis 5, and an arrowhead-shaped anchor portion 7 (corresponding to a locking claw portion of the present disclosure) that gradually narrows at one tip portion of the plate-shaped insertion portion 6. At least a claw-shaped portion of the arrowhead (anchor) of the anchor portion 7 is configured to be elastically expandable and contractible, and is provided with a pressing portion 8 and a locking portion 9 at the rear end portion of the arrowhead-shaped portion. In the embodiment of the present disclosure, the anchor portion 7 has a bilaterally symmetrical and front-back symmetrical shape with respect to an anchor axis 5.

Next, in the second member 3 which is the other member of the fixing structure 1, a lock portion 11 (corresponding to a frame portion of the present disclosure) having an anchor hole 10 formed on one side of a rectangular member having a boss portion is attached to an attachment surface 12. The anchor hole 10 is a hole for inserting the anchor portion 7 in the axial direction of the anchor axis 5, and in the embodiment of the present disclosure, the anchor hole 10 has a rectangular shape on a plane perpendicular to the anchor axis 5 (plan view in FIG. 1).

In the above-mentioned configuration, in order to fasten the first member 2 and the second member 3 to each other, the anchor member 4 (plate-shaped insertion portion 6) is first inserted from top to bottom into the anchor hole 10, and after the anchor member 4 has passed through the anchor hole 10, the locking portion 9 of the anchor portion 7 engages with the lower end portion of the lock portion 11, thereby fastening the first member 2 and the second member 3. However, the anchor portion 7 has a bilaterally symmetrical or front-back symmetrical shape, so that when a fastening work is repeated, it is unavoidable to fasten the first member 2 and the second member 3 with the left and right sides or the front and back sides being reversed, which may cause trouble in post-processes or result in rejected products.

Focusing on the above technical problem, the fixing structure 1 of the present disclosure includes a ridge portion 13 and a groove portion 14 that are provided to the plate-shaped insertion portion 6 and the lock portion 11, respectively. The structure will be further described. The ridge portion 13 extending in an insertion direction (the direction of the anchor axis 5) to the anchor hole 10 is formed at a location of the plate-shaped insertion portion 6 that is to face a predetermined location on the inner surface of the anchor hole 10. Specifically, the ridge portion 13 has a protruding shape that extends by a predetermined length from the other end portion to the one end portion of the anchor axis 5 in the plate-shaped insertion portion 6 (from an upper end portion toward a lower end portion as shown in front view of FIG. 1).

A groove portion 14 whose shape is similar to the protruding shape of the ridge portion 13 of the plate-shaped insertion portion 6 is formed in a direction perpendicular to the attachment surface 12 in the lock portion 11. Note that the groove portion 14 in the embodiment of the present disclosure is formed to be cut out in the attachment surface 12 deeply up to a predetermined length. However, the groove portion 14 is not limited to this style, and may penetrate through the attachment surface 12.

Here, the ridge portion 13 and the lock portion 11 will be described. A thickness 16 of the plate-shaped insertion portion 6 at the ridge portion 13 on a plane perpendicular to the anchor axis 5 is set to be larger than an opening width 17 at a location outside the groove portion 14 of the anchor hole 10. Also, a length B from a tip portion 15 of the ridge portion 13 to the locking portion 9 of the anchor portion 7 that engages with the lock portion 11 is set to be smaller than the length A (the width of the lock portion 11) in the insertion direction of the anchor hole 10 on the attachment surface 12.

When the fixing structure 1 of the present disclosure is assembled, the anchor portion 7 of the first member 2 is inserted into the anchor hole 10 of the second member 3. Specifically, when the fixing structure 1 is viewed from above, the ridge portion 13 of the anchor portion 7 faces the groove portion 14 side of the lock portion 11 (the attachment surface 12 side).

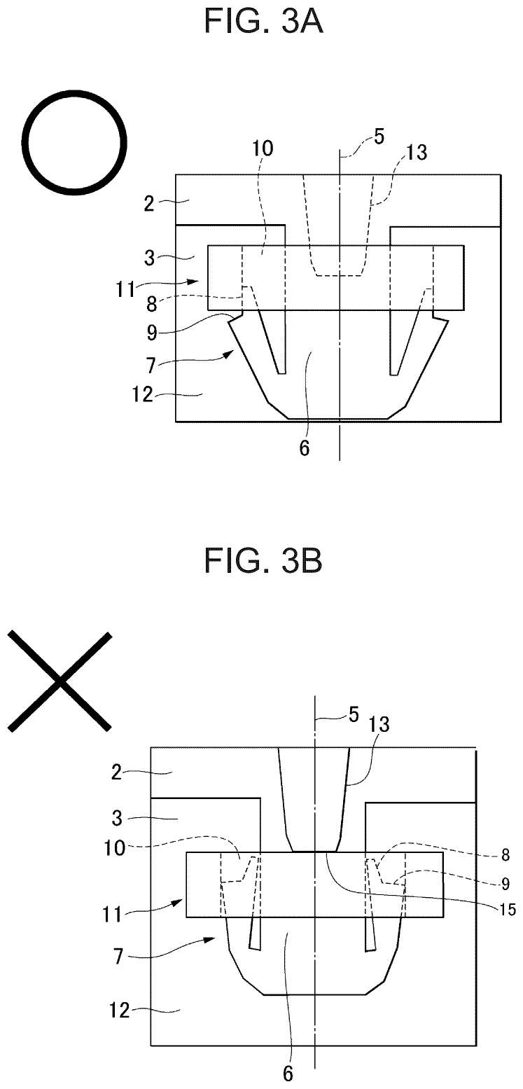

The plate-shaped insertion portion 6 and the anchor portion 7 pass through the anchor hole 10, and the pressing portion 8 of the anchor portion 7 presses at least a part of the anchor hole 10, and the locking portion 9 comes out of the anchor hole 10 and locks. Specifically, the locking is performed by the surface of the locking portion 9 engaging with the lower surface of the lock portion 11 and the surface of the pressing portion 8 that extends from the surface of the locking portion 9 to the rear end side thereof and engages with the inner surface of the lock portion 11. Then, the ridge portion 13 is fitted into the groove portion 14 and fixed (this is a state shown in FIG. 3A).

In an example of incorrect assembling, when an attempt is made to insert the plate-shaped insertion portion 6 into the anchor hole 10 in a state where the anchor member 4 is turned upside down, the tip portion 15 of the ridge portion 13 interferes with the lock portion 11, making the insertion impossible (this is a state shown in FIG. 3B). In addition, even when an attempt is made to insert the anchor member 4 into the anchor hole 10 from bottom to top in the direction of the anchor axis 5 in FIG. 2, it would not be possible to insert the anchor member 4 because no groove portion 14 is formed in the second member 3 in the first place. Accordingly, it is possible to avoid fastening the anchor member 4 upside down during the fastening work, and prevent incorrect assembling.

The above embodiment is merely one example when the present disclosure is implemented, and does not limit the present disclosure. For example, in the embodiment, the sectional shape of the plate-shaped insertion portion 6 is oblong (rectangular), but the embodiment is not limited to this style. As long as the thickness 16 at the ridge portion 13 of the plate-shaped insertion portion 6 is larger than the opening width 17 of the anchor hole 10, the sectional shape of the insertion portion may be circular, elliptical, or polygonal. Therefore, the shape of the opening of the anchor hole 10 is also not limited to the oblong described in the embodiment as long as the anchor hole is shaped to be capable of fitting to the anchor portion 7.

What is claimed is:

1. A fixing structure comprising:
a shaft portion provided on a first member;
an anchor portion having a locking claw portion at a tip portion of the shaft portion, the locking claw portion being elastically expandable and contractible; and
a frame portion that is provided on a second member and has an anchor hole into which the shaft portion is to be inserted, the second member being configured to be assembled to the first member such that the shaft portion is inserted into the anchor hole, and a locking portion of the locking claw portion that has passed through the anchor hole engages with an end portion of the frame portion, wherein:
a ridge portion extending in an insertion direction toward the anchor hole is formed at a location of the shaft portion that is to face a predetermined location on an inner surface of the anchor hole;
a groove portion into which the ridge portion can be inserted in the insertion direction is formed at the predetermined location on the inner surface of the anchor hole;
a thickness of a portion of the shaft portion at the ridge portion is larger than an opening width at a location outside the groove portion of the anchor hole; and
a length from a tip portion of the ridge portion to the locking portion of the locking claw portion that is to engage with the frame portion is smaller than a length in the insertion direction of the anchor hole.

2. The fixing structure according to claim 1, wherein the locking claw portion has an arrowhead shape that is bilaterally symmetrical and gradually narrows on a tip side of the shaft portion, and has the locking portion formed at a rear end portion of a portion having the arrowhead shape.

3. The fixing structure according to claim 1, wherein the locking portion has a surface that is to engage with a lower surface of the frame portion, and a surface that extends from the surface to a rear end side and is to engage with an inner surface of the frame portion.

4. The fixing structure according to claim 1, wherein:
the shaft portion has a rectangular sectional shape;
the ridge portion has a rectangular sectional shape; and
an opening of the anchor hole is formed in a rectangular shape.

5. The fixing structure according to claim 3, wherein:
the shaft portion has a rectangular sectional shape;
the ridge portion has a rectangular sectional shape; and
an opening of the anchor hole is formed in a rectangular shape.
